(19) United States
(12) Patent Application Publication
(10) Pub. No.: US 2012/0111916 A1
(43) Pub. Date: May 10, 2012

(54) STAPLER

(75) Inventor: Kun-Hon CHEN, Taichung County (TW)

(73) Assignee: SAME YONG INDUSTRIAL CO., LTD., Dali City (TW)

(21) Appl. No.: 12/940,421

(22) Filed: Nov. 5, 2010

(51) Int. Cl. B25C 5/00

(52) U.S. Cl. 227/110

(57) ABSTRACT

A stapler includes left and right shells, a front shell, a staple magazine, an urging plate and a controlling switch. The left and right shells are connected with each other, such that a receiving space is defined therebetween. The front shell is connected with front portions of the left and right shells and provided with an opening in communication with the receiving space. The staple magazine is detachably disposed in the receiving space and the urging plate is disposed in front of the staple magazine. The controlling switch is reciprocally slidably disposed in the opening of the front shell and adapted to adjust a gap between the staple magazine and the urging plate for fitting various staples having different thickness. Because the front side of the front shell is seamless without connective joint, the stapler is strong in structure and durable in use.

### BACKGROUND OF THE INVENTION

1. Field of the Invention

The present invention relates generally to staplers and more particularly, to a stapler fittable with various staples having different thickness.

2. Description of the Related Art

U.S. Pat. No. 7,770,771 entitled “Stapler With Adjustable Firing Apparatus For Using Staples/Nails In Various Sizes” disclosed a stapler that is designed to be selectively used in cooperation with various sized staples including a T-shaped staple, I-shaped staple, U-shaped staple, and an inverted U-shaped staple. The stapler includes an adjustable firing apparatus having an adjusting mechanism and a rotation engaged member having first and second engaged portions. An actuating mechanism that can drive the rotation engaged member to move the adjusting mechanism is used to adjust the distance between the adjusting mechanism and the front of a magazine assembly of the stapler to be adapted to use staples/nails in various sizes.

In the above-mentioned US patent, a teeth engagement is adopted between the rotation engaged member and the actuating means, resulting in that the matched elements are complicated in configuration so as to be inconveniently made. In addition, the stapler requires more precise in assembly and more particularly, additional jigs may be involved in assembling of the stapler. Therefore, it is desired to provide an improved stapler.

### SUMMARY OF THE INVENTION

The present invention has been accomplished in view of the above-noted circumstances. It is therefore an object of the present invention to provide a stapler, which is suitable for use in cooperation with various staples having different size and is easy in operation, simple and strong in structure and durable in use.

To attain the above-mentioned object, a stapler provided by the present invention comprises left and right shells, which are connected with each other such that a receiving space is defined therebetween, a front shell, which is connected with front portions of the left and right shells and provided with an opening in communication with the receiving space, a staple magazine detachably disposed in the receiving space, an urging plate disposed in front of the staple magazine, and a controlling switch, which is disposed in the front shell in such a way that the controlling switch is reciprocally slidable leftwards and rightwards in the opening of the front shell for adjusting a gap between the staple magazine and the urging plate, such that the gap is adjustable to fit various staples. Because the front side of the front shell is seamless without connective joint, the stapler is strong in structure and durable in use.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is an assembled perspective view of a stapler according to a preferred embodiment of the present invention;

FIG. 2 is an exploded perspective view of the stapler of FIG. 1;

FIG. 3 is another exploded perspective view of the stapler of FIG. 1 when viewed from another viewing angle;

FIG. 4 is a sectional view showing that a controlling switch of the stapler of the preferred embodiment of the present invention is located at a first position;

FIG. 5 is similar to FIG. 4 but showing that the controlling switch is located at a second position;

FIG. 6 is a rear view showing that the controlling switch is disposed in a front shell of the stapler and located at the first position, and

FIG. 7 is similar to FIG. 6 but showing that the controlling switch is located at the second position.

### DETAILED DESCRIPTION OF THE INVENTION

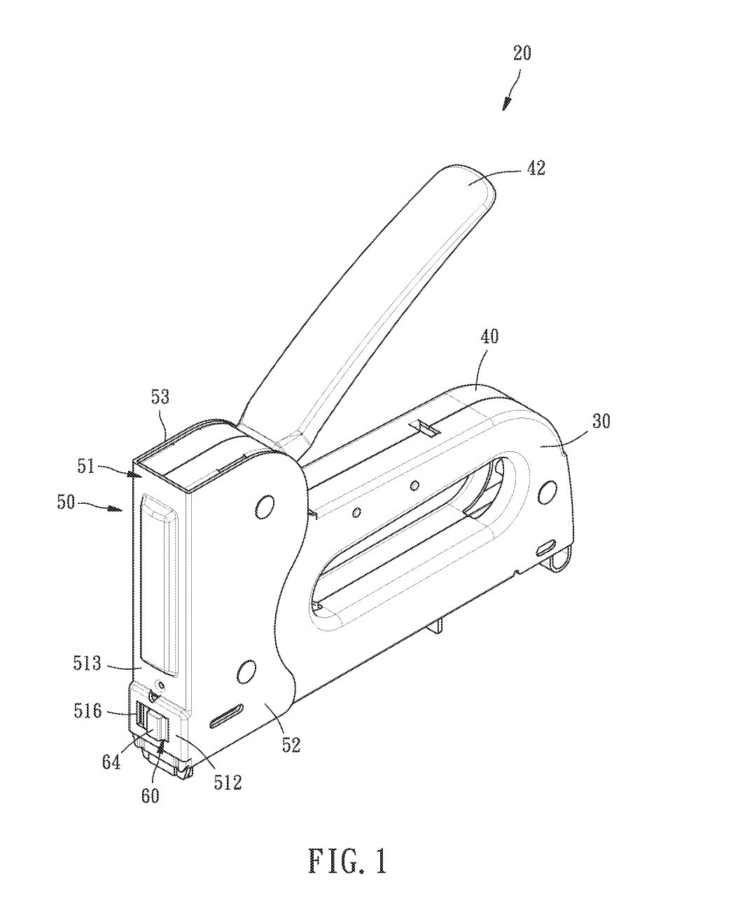

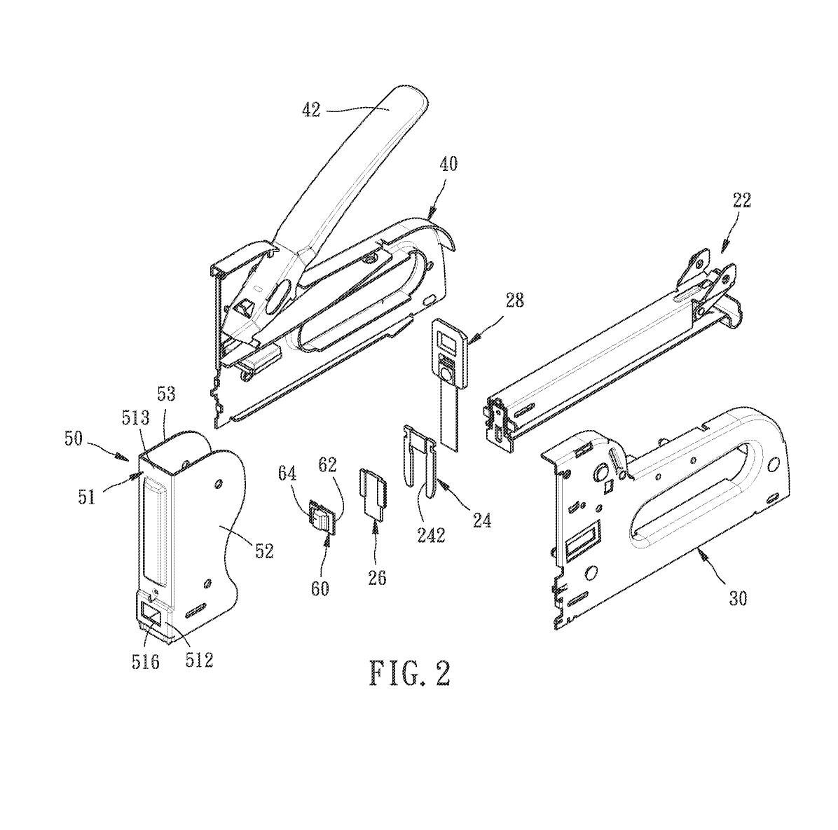

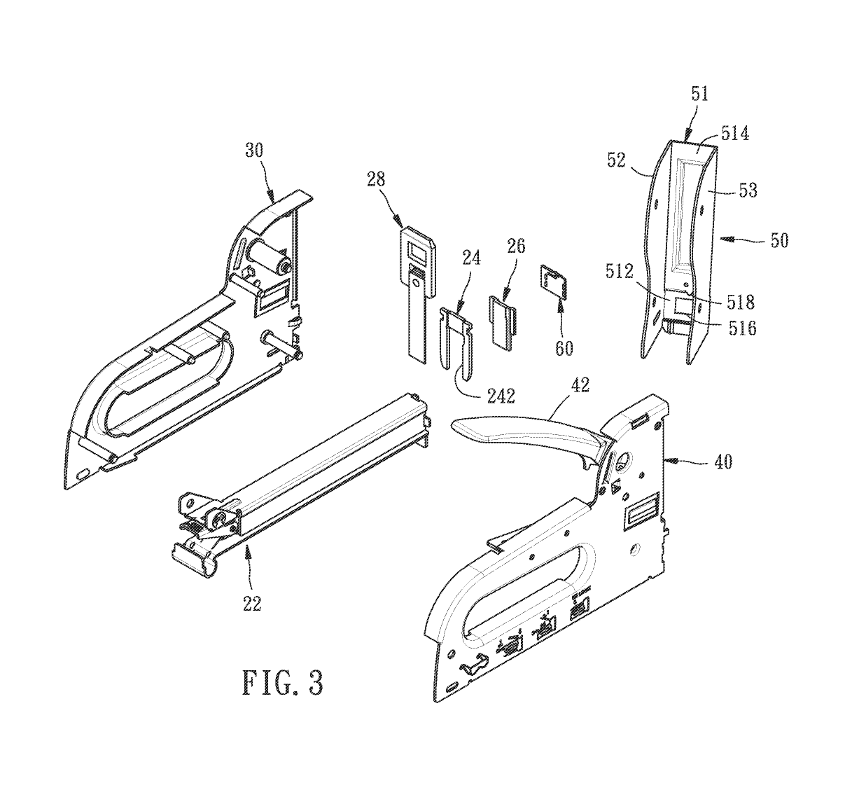

As shown in FIGS. 1-3, a stapler 20, which is provided by a preferred embodiment of the present invention and fittable with two kinds of staples having different thickness, comprises a staple magazine 22, a guide plate 24, an urging plate 26, a striker 28, a left shell 30, a right shell 40, a front shell 50 and a controlling switch 60.

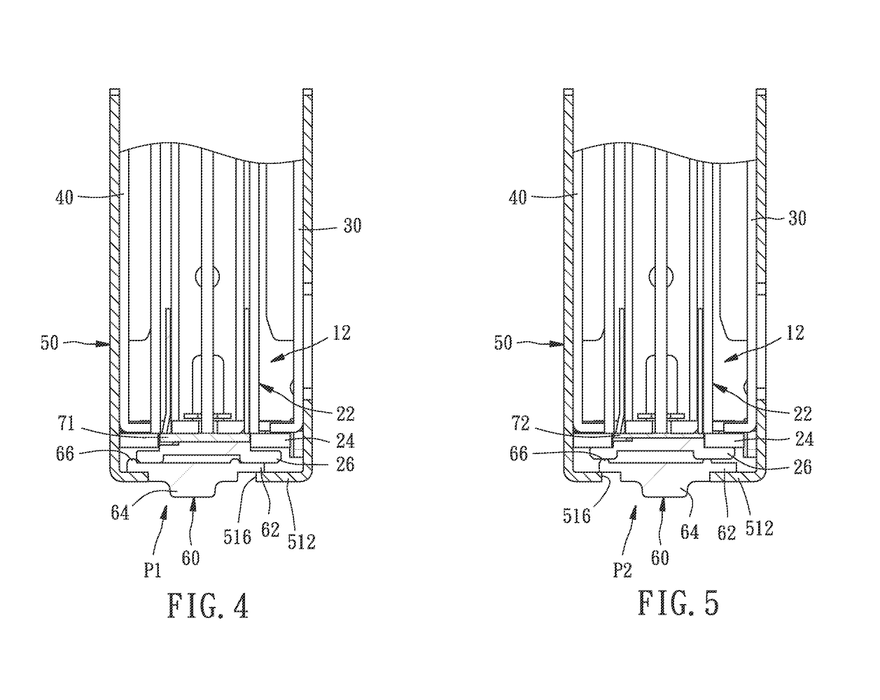

The left shell 30 and the right shell 40 are connected with each other, such that a receiving space 12, as shown in FIGS. 4 and 5, is formed between the left and right shells 30 and 40 and provided with an open at front end surfaces of the left and right shells 30 and 40. The receiving space 12 is designed to accommodate the staple magazine 22. In front of the staple magazine 22 the guide plate 24 and the urging plate 26 are arranged in sequence. A trigger handle 42 is pivotally installed between front top portions of the left and right shells 30 and 40 and pressable by a user to drive the striker 28 downwardly. The striker 28 is downwardly moveable along a guide channel 242, which is provided at a backside of the guide plate 24, to impact a staple located at a gap formed between the staple magazine 22 and the urging plate 26.

The front shell 50 has left and right plates 52 and 53 and an intermediate plate 51 integrally connected between front ends of the left and right plates 52 and 53 at a right angle. The lower part of the intermediate plate 51 is provided with an accommodation portion 512, which is formed by a stamping process or molding in such a way that the accommodation portion 512 is convex at a front surface 513 of the intermediate plate 51 and concave at a rear surface 514 of the intermediate plate 51. In addition, the intermediate plate 51 includes a rectangular opening 516 at a center of the accommodation portion 512, and a retaining stopper 518 extending into the concave portion of the accommodation portion 512 and located above the opening 516. The front shell 50 is sleeved onto and firmly connected with front portions of the left and right shells 30 and 40 in such a way that the rear surface 514 of the intermediate plate 51 is spaced at a predetermined distance from the front end surfaces of the left and right shells 30 and 40, and the left plate 52 is connected with and covers on the front portion of the left shell 30, and the right plate 53 is connected with and covers on the front portion of the right shell 40. As a result, the front shell 50 blocks the front open of the combined left and right shells 30 and 40, and the opening 516 is in alignment and communication with the guide channel 242 of the guide plate 24.

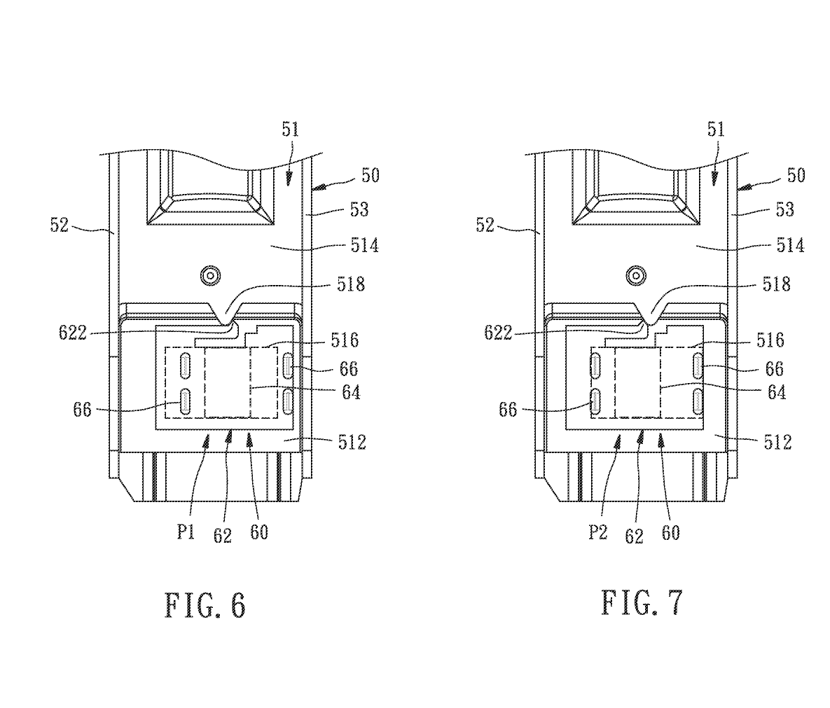

Referring to FIGS. 1-7, the controlling switch 60 has a base plate 62, an operable tab 64 protruding from a front surface of the base plate 62, and four protrusions 66 on a rear surface of the base plate 62. The protrusions 66 include a first pair and a second pair arranged respectively adjacent to a right edge and a left edge of the rear surface of the base plate 62 of the controlling switch 60. The base plate 62 of the controlling switch 60 is slidably mounted inside the concave portion of the accommodation portion 512 of the front shell 50 in such a way that the operable tab 64 extends through the opening 516 of the front shell 50 and is exposed to be accessible by a user, and the protrusions 66 face the receiving space 12 and are selectively contactable with the urging plate 26. Specifically speaking, on the top of the base plate 62 a positioning portion 622 is provided, and the controlling switch 60 is, through the user's operation of the operable tab 64, reciprocally slidable leftwards and rightwards in the accommodation portion 512 between a first position P1 and a second position P2. When the controlling switch 60 is rested at the first position P1, the positioning portion 622 of the controlling switch 60 is stopped at a right side of the retaining stopper 518 of the front shell 50, as shown in FIG. 6, and at this moment the rear surface of the base plate 62 beyond the protrusions 66 is in contact with the urging plate 26, as shown in FIG. 4, such that a relatively larger gap is formed between the staple magazine 22 and the urging plate 26 for fitting a staple 71 having a relatively larger thickness in the ready-to-fire position. On the other hand, when the controlling switch 60 is moved by a user from the first position P1 to the second position P2, the positioning portion 622, in the process of movement, will slide over the retaining stopper 518 and be eventually stopped at a left side of the retaining stopper 518 of the front shell 50, as shown in FIG. 7, and the protrusions 66 of the base plate 62, which are in contact with the urging plate 26 as shown in FIG. 5, will push the urging plate 26 to move backwards, such that a relatively smaller gap is formed between the staple magazine 22 and the urging plate 26 for fitting a staple 72 having a relatively smaller thickness in the ready-to-fire position.

As indicated above, the user can set the controlling switch 60 at the first position P1 or the second position P2 subject to the thickness of the staples loaded in the staple magazine 22 for enabling the striker 28 to strike exactly one staple at a time so as to smoothly eject the right staple out of the stapler 20. Because the front portion of the housing of the stapler 20, which is located in proximity to the position where the striker 28 strikes the staple, is formed by the front shell 50 which is seamless at a front side thereof, i.e. without a connective joint at the front side thereof, the housing of the stapler 20 can provide a strong structural strength at the front portion thereof to prevent damage due to strike force generated by the striker 28, resulting in that the stapler 20 is durable in use.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A stapler, comprising:
left and right shells connected with each other and defining a receiving space therebetween;
a front shell connected with front portions of the left and right shells and provided with an opening in communication with the receiving space;
a staple magazine detachably disposed in the receiving space;
an urging plate disposed in front of the staple magazine; and
a controlling switch disposed in the front shell in a way that the controlling switch is reciprocally slidable leftwards and rightwards in the opening of the front shell for adjusting a gap between the urging plate and the staple magazine for fitting various staples.

2. The stapler as claimed in claim 1, wherein the front shell comprises a front surface, a rear surface and an accommodation portion that is concave on the rear surface and provided with the opening.

3. The stapler as claimed in claim 2, wherein the controlling switch comprises a base plate slidably disposed in the accommodation portion of the front shell and provided with a protrusion facing the receiving space, and an operable tab that protrudes from the base plate and is located in the opening and exposed to be accessible by a user.

4. The stapler as claimed in claim 3, wherein the front shell comprises a retaining stopper extending into the accommodation portion, and the controlling switch comprises a positioning portion stoppable at the retaining stopper; wherein the controlling switch is slidably moveable relative to the front shell between a first position where the positioning portion of the controlling switch is stopped at one of left and right sides of the retaining stopper, and a second position where the positioning portion of the controlling switch is stopped at the other one of the left and right sides of the retaining stopper.

5. The stapler as claimed in claim 2, wherein the front shell comprises a retaining stopper extending into the accommodation portion and the controlling switch comprises a positioning portion stoppable at the retaining stopper; wherein the controlling switch is slidably moveable relative to the front shell between a first position where the positioning portion of the controlling switch is stopped at one of left and right sides of the retaining stopper, and a second position where the positioning portion of the controlling switch is stopped at the other one of the left and right sides of the retaining stopper.

6. The stapler as claimed in claim 1, wherein the front shell comprises a left plate, a right plate and an intermediate plate integrally connected between the left and right plates; the front shell is sleeved onto the front portions of the left and right shells in a way that the left plate of the front shell is connected with and covers on the front portion of the left shell and the right plate of the front shell is connected with and covers on the front portion of the right shell.

7. The stapler as claimed in claim 6, wherein the intermediate plate of the front shell comprises a front surface, a rear surface and an accommodation portion that is concave on the rear surface and provided with the opening.

8. The stapler as claimed in claim 7, wherein the controlling switch comprises a base plate slidably disposed in the accommodation portion of the intermediate plate of the front shell and provided with a protrusion facing the receiving space, and an operable tab that protrudes from the base pate and is located in the opening and exposed to be accessible by a user.

9. The stapler as claimed in claim 8, wherein the intermediate plate of the front shell comprises a retaining stopper extending into the accommodation portion, and the controlling switch comprises a positioning portion stoppable at the retaining stopper; wherein the controlling switch is slidably moveable relative to the front shell between a first position where the positioning portion of the controlling switch is stopped at one of left and right sides of the retaining stopper, and a second position where the positioning portion of the controlling switch is stopped at the other one of the left and right sides of the retaining stopper.

10. The stapler as claimed in claim 7, wherein the intermediate plate of the front shell comprises a retaining stopper extending into the accommodation portion and the controlling switch comprises a positioning portion stoppable at the retaining stopper; wherein the controlling switch is slidably moveable relative to the front shell between a first position where the positioning portion of the controlling switch is stopped at one of left and right sides of the retaining stopper, and a second position where the positioning portion of the controlling switch is stopped at the other one of the left and right sides of the retaining stopper.
